(19) United States
(12) Patent Application Publication
(10) Pub. No.: US 2023/0147192 A1
(43) Pub. Date: May 11, 2023

(54) SPIKING NEURAL NETWORK PROVIDING DEVICE AND OPERATING METHOD THEREOF

(71) Applicant: SEOUL NATIONAL UNIVERSITY R&DB FOUNDATION, Seoul (KR)

(72) Inventors: Byung-Gook PARK, Seoul (KR); Sungmin HWANG, Seoul (KR)

(21) Appl. No.: 18/090,424

(22) Filed: Dec. 28, 2022

Related U.S. Application Data
(63) Continuation of application No. PCT/KR2022/017203, filed on Nov. 4, 2022.

(30) Foreign Application Priority Data
Nov. 4, 2021 (KR) 10-2021-0150824
Jun. 14, 2022 (KR) 10-2022-0071866

(51) Int. Cl. G06N 3/049; G06N 3/08

(52) U.S. Cl. CPC G06N 3/049; G06N 3/08

(57) ABSTRACT

A spiking neural network providing device simulates a plurality of neuron layers and a plurality of synaptic layers, processes a spike signal, and applies a predetermined delay to timing when a bias is provided to the plurality of neuron layers.

### BACKGROUND

### 1. Field

The present invention relates to a spiking neural network providing device and an operating method of the spiking neural network providing device.

### 2. Description of the Related Art

Recently, research and development on a spiking neural network (SNN) have been actively conducted together with development of a computing technology based on an artificial neural network. Although the spiking neural network originated from imitation of the actual biological nervous system (concept of memory, learning, and inference), the spiking neural network adopts a similar network structure and differs from the actual biological nervous system in various aspects, such as signal transmission, an information expression method, and a learning method.

Meanwhile, the hardware-based SNN that operates almost the same as the actual neural network is rarely used in the actual industry because a learning method that outperforms the existing neural network has not yet been developed. However, when a synaptic weight is derived by using the existing neural network and inference is made by using an SNN method, a high-accuracy and ultra-low-power computing system can be implemented, and research on this is being actively conducted.

In addition, in the general artificial neural network, a bias also plays an important role in a learning process along with a weight. The weight represents a value multiplied by an input signal in a perceptron structure or the like representing an artificial neural network model, and the bias represents a constant added to a product of the input signal and the weight.

It is known that the known spiking neural network does not use the bias other than applying the weight. However, the most artificial neural network models use the bias, and the bias is inevitably generated when a batch normalization technique is used. In order to overcome this, a method of implementing the bias at the maximum ignition rate has been proposed, but this method is not suitable for a spiking neural network method because the bias of the traditional neural network is simply transferred.

Unlike the traditional artificial neural network, the spiking neural network has latency required to pass through each synaptic layer and each neuron layer, and thus, in consideration of this, a method for applying a bias is proposed. More specifically, it is necessary to wait for a time for a membrane potential of a charging element to be charged in order to generate a spike, and previous layers have to be sequentially ignited to be ignited in a subsequent layer, and thereby, a delay time occurs.

When only a bias is applied while a delay occurs in a specific layer, the membrane potential of the layer is controlled only by the bias, and accordingly, an ignition rate of a corresponding layer is greatly reduced or an error occurs due to excessive ignition. Therefore, the present invention provides a method for accurately using a bias.

### SUMMARY

An object of the present invention is to provide a spiking neural network providing device and a method of operating the spiking neural network providing device that may apply a bias during an operation of the spiking neural network providing device.

However, a technical object to be solved by the present embodiment is not limited to the technical object described above, and there may be other technical objects.

According to an aspect of the present disclosure, a spiking neural network providing device includes a plurality of neuron layers, and a plurality of synaptic layers, wherein the plurality of neuron layers, and the plurality of synaptic layers are simulated, a spike signal is processed, and a predetermined delay is applied to timing when a bias is provided to the plurality of neuron layers.

According to another aspect of the present disclosure, an operating method of a spiking neural network providing device that simulates a plurality of neuron layers and a plurality of synaptic layers, includes inputting input data to the spiking neural network providing device, and performing inference, by the plurality of neuron layers and the plurality of synaptic layers, based on learning model data including weights and biases stored in the plurality of synaptic layers, wherein the performing of the inference is to apply the predetermined delay to the timing when the bias is provided to the plurality of neuron layers.

When a bias of a spiking neural network device is implemented by using the known method, a membrane potential of a neuron is controlled only by the bias during initial time. Accordingly, ignition is greatly reduced according to a sign of the bias, causing a serious delay time, or overcharging of the membrane potential, and thereby, over-ignition occurs.

However, according to a method proposed by the present invention, a bias is applied according to a latency of a synaptic layer or a neuron layer to reduce excessive suppression and excessive ignition, and thus, a spiking neural network with more accuracy and faster performance may be implemented.

### BRIEF DESCRIPTION OF THE DRAWINGS

FIG. 1 is a block diagram illustrating a configuration of a hardware-based spiking neural network providing device according to an embodiment of the present invention;

FIG. 2 is a block diagram illustrating a configuration of a software-based spiking neural network providing device according to an embodiment of the present invention;

FIG. 3 is a flowchart illustrating an operating method of a spiking neural network providing device according to an embodiment of the present invention;

FIGS. 4 and 5 are diagrams illustrating a concept of providing a bias during an operation of the spiking neural network providing device according to an embodiment of the present invention; and

FIGS. 6A and 6B are graphs illustrating effects when a delay is applied according to an embodiment of the present invention.

### DETAILED DESCRIPTION

Hereinafter, embodiments of the present disclosure will be described in detail with reference to the accompanying drawings such that those skilled in the art to which the present disclosure belongs may easily implement the present disclosure. However, the present disclosure may be embodied in various different forms and is not limited to the embodiments described herein. In addition, in order to clearly illustrate the present disclosure in the drawings, parts irrelevant to the descriptions are omitted, and similar reference numerals are attached to similar parts throughout the specification.

Throughout the specification, when a portion is “connected” or “coupled” to another portion, this includes not only a case of being “directly connected or coupled” but also a case of being “electrically connected” with another element interposed therebetween.

Throughout the specification, when a member is said to be located “on” another member, this includes not only a case in which the member is in contact with another member but also a case in which there is another member between the two members.

A spiking neural network providing device according to the present invention means that a spiking neural network is implemented in hardware or software. A hardware-based spiking neural network includes a synaptic device corresponding to a brain synapse, a neuronal circuit corresponding to neurons, and various peripheral circuits. A software-based spiking neural network indicates a spiking neural network implemented by a computer program in a computing device.

Hereinafter, embodiments of the present invention will be described in detail with reference to the accompanying drawings.

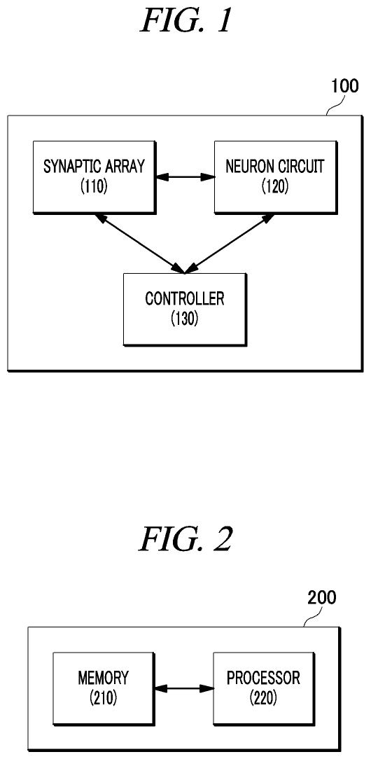

FIG. 1 is a block diagram illustrating a configuration of a hardware-based spiking neural network providing device according to an embodiment of the present invention.

As illustrated, the spiking neural network providing device 100 includes a synaptic array 110, a neuron circuit 120, and a controller 130 for controlling operations thereof.

The synaptic array 110 includes a plurality of synaptic elements, is implemented to perform the same functions as a brain synapse, and is implemented generally based on a non-volatile memory device. The synaptic array 110 corresponds to a plurality of synaptic cells, and stores predetermined weights and biases. The synaptic array may include a front-end neuron circuit and a back-end neuron circuit which are connected to each other and include synaptic cells corresponding to a product of the number of a front-end neuron circuit and a back-end neuron circuit. An operation of storing a weight or a bias in the synaptic array or a process of reading the stored weight or bias is performed through the same principle as a program operation or a read operation performed by a general non-volatile memory device.

The neuron circuit 120 may be divided into the front-end neuron circuit or a pre-neuron circuit coupled to a front end of the synaptic array 110 and a rear-end neuron circuit or a post-neuron circuit coupled to a rear end of the synaptic array 110. The neuron circuit 120 includes a signal integrator for integrating a signal transmitted through the immediately preceding synapse, a comparator for comparing whether or not an integrated signal is greater than or equal to a threshold, and so on, and when the integrated signal is greater than the threshold as a result of the comparison, a spike signal is output according to an ignition operation. Meanwhile, in relation to a configuration of the signal integrator, an embodiment in which a signal is integrated by using a capacitor is generally known.

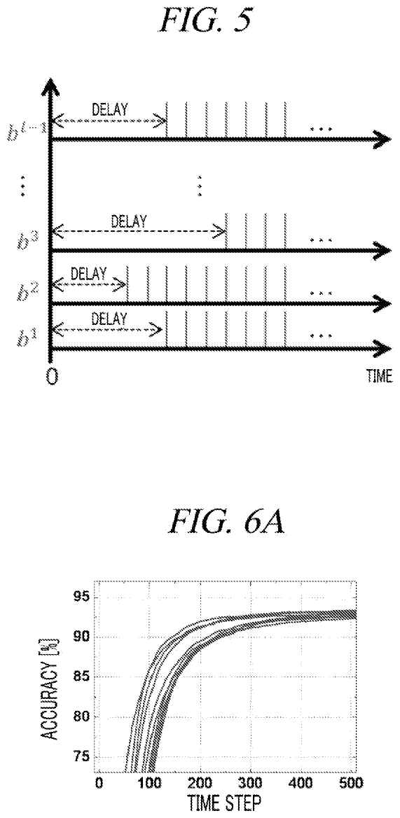

As described above, the synaptic array 110 and the neuron circuit 120 are illustrated as two blocks separated from each other, but in the form of FIG. 4, a plurality of synaptic layers and a plurality of neuron layers may operate in an alternately arranged state by adjusting an electrical connection state of respective components.

The controller 130 controls operations of the synaptic array 110 and the neuron circuit 120. In addition, the controller 130 may include a peripheral circuit that performs an operation of programming a weight or a bias for the synaptic array 110 and an operation of reading the stored weight or bias. In addition, the controller 130 may include various voltage supply modules for performing operations, such as incremental step pulse program (ISPP) or incremental step pulse erase (ISPE) for the synaptic array 110 in order to adjust the weight or bias. In addition, the controller 130 may perform a program operation, an erase operation, and so on of the weight or bias suitable for characteristics of the synaptic array 110.

In addition, the controller 130 may cause learning model data including a weight and a bias to be stored in a synaptic layer, and cause each synaptic layer to output a value obtained by combining a spiking signal output from a previous neuron layer and a weight with each other, and control a neuron layer to add the bias to an output value transmitted from the previous synaptic layer and output the result.

In addition, the controller 130 applies a predetermined delay to timing when the bias is provided to neuron layers of the plurality of neuron layers. This will be described in detail below.

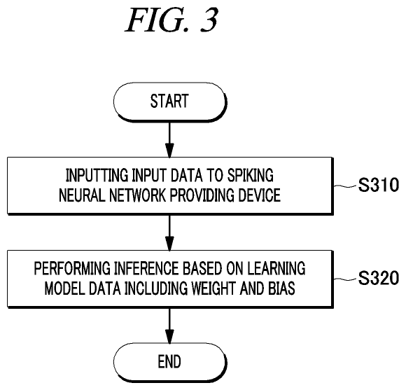

FIG. 2 is a block diagram illustrating a configuration of a software-based spiking neural network providing device according to an embodiment of the present invention.

As illustrated, a spiking neural network providing device 200 is implemented in the form of a computing device basically including a memory 210 and a processor 220, and may include a communication module, a peripheral device for various 10 processing, a power supply, and so on.

A program for providing a spiking neural network is stored in the memory 210, and a spiking neural network in which a plurality of synaptic layers and a plurality of neuron layers are alternately arranged is implemented in software by the corresponding program.

In addition, a spiking neural network program stores learning model data including a weight and a bias in each synaptic layer, and each synaptic layer outputs a value obtained by combining the spiking signal output from the previous neuron layer and the weight, and the neuron layer may output a value obtained by adding the bias to an output value transmitted from the previous synaptic layer.

In addition, the spiking neural network program applies a predetermined delay to the timing when the bias is provided to neuron layers of the plurality of neuron layers. This will be described in detail below.

The memory 210 includes a non-volatile storage device that continuously retains the stored information even when power is not supplied and a volatile storage device that requires power to maintain the stored information. In addition, the memory 210 may temporarily or permanently store the data processed by the processor 220.

The processor 220 executes a program that provides a spiking neural network stored in the memory 210. The processor 220 may include various types of devices that control and process data. The processor 220 may include a data processing device embedded in hardware having a physically structured circuit to perform functions expressed by codes or instructions included in a program. In one example, the processor 220 may include a microprocessor, a central processing unit (CPU), a processor core, a multiprocessor, an application-specific integrated circuit (ASIC), a field programmable gate array (FPGA), and so on, but the scope of the present invention is not limited thereto.

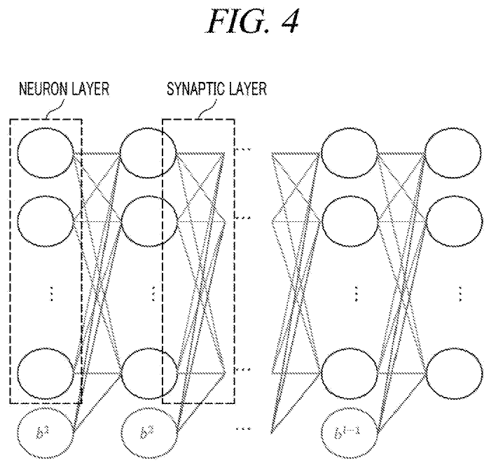

FIG. 3 is a flowchart illustrating an operating method of a spiking neural network providing device, according to an embodiment of the present invention, and FIGS. 4 to 5B illustrate a concept of providing a bias in an operating process of the spiking neural network providing device according to an embodiment of the present invention.

First, input data is input to the spiking neural network providing device 100 or 200 (S310). In this case, the input data is a value input to derive an inference result from the spiking neural network providing device 100 or 200. That is, a weight and a bias of learning model data for which learning is completed is stored in a synaptic layer of the spiking neural network providing device 100 or 200, and the input data is input to the spiking neural network providing device 100 or 200 in this state.

Next, inference for the input data is performed through the spiking neural network providing devices 100 or 200 (S320).

In this case, each of the spiking neural network providing devices 100 and 200 provides a state in which a plurality of synaptic layers and a plurality of neuron layers are alternately arranged, as illustrated in FIG. 4.

In addition, as illustrated in FIG. 5, a predetermined delay is applied to timing when the bias is provided to neuron layers of the plurality of neuron layers. Preferably, the delay is applied such that the bias is provided at the same time as or after a point in time when a spiking signal is transmitted from each synaptic layer to the neuron layer. A degree of delay applied to bias provision may be different for each layer.

In addition, the delay of the bias to be provided may be adjusted according to a latency of the neuron layer to which the bias is provided or a latency of the synaptic layer located at a front end of the neuron layer to which the corresponding bias is provided. In addition, different delays may be applied depending on sizes of the entire spiking neural network, applied products, or complexity of a pattern to be used. The delay may be adjusted by a designer according to each design direction. For example, a delay in the range of ns to μs may be applied thereto.

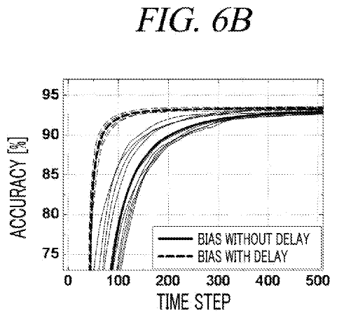

FIGS. 6A and 6B are graphs illustrating effects when a delay is applied according to an embodiment of the present invention.

A spiking neural network for simulation has a total of nine layers and was trained by including a bias term. For testing, a total of 10 weight sets were trained in the same structure. First, as illustrated in FIG. 6A, it can be seen that there is a significant deviation in performance results over time when a bias is implemented as an input having the greatest ignition rate as in the known method. In all cases, as inference time increases, the bias converges to the highest accuracy, but it can be seen that the time required for convergence in each case is not constant and has a large deviation. This can be seen as an effect due to excessive suppression and excessive ignition when the bias is implemented to have the greatest ignition rate.

In contrast to this, when a delay is applied to the bias, as illustrated in FIG. 6B, it can be seen that a deviation of convergence with increasing time is significantly reduced, and the time to reach convergence is also reduced. Furthermore, it can be seen that accuracy of inference also increases to a certain extent.

One embodiment of the present disclosure may also be implemented in the form of a recording medium including instructions executable by a computer, such as a program module executed by the computer. Computer-readable media may be any available media that may be accessed by a computer and include both volatile and nonvolatile media and removable and non-removable media. In addition, the computer-readable media may include all computer storage media. The computer storage media includes both volatile and nonvolatile media and removable and non-removable media implemented by any method or technology of storing information, such as a computer readable instruction, a data structure, a program module, and other data.

Although the method and system according to the present disclosure are described with reference to specific embodiments, some or all of their components or operations may be implemented by using a computer system having a general-purpose hardware architecture.

The above descriptions on the present disclosure are for illustration, and those skilled in the art to which the present disclosure pertains may understand that the descriptions may be easily modified into other specific forms without changing the technical idea or essential features of the present disclosure. Therefore, it should be understood that the embodiments described above are illustrative in all respects and not restrictive. For example, each component described as a single type may be implemented in a dispersed form, and likewise components described as distributed may be implemented in a combined form.

The scope of the present disclosure is indicated by the following claims rather than the above detailed description, and all changes or modifications derived from the meaning and scope of the claims and their equivalents should be interpreted as being included in the scope of the present disclosure.

What is claimed is:

1. A spiking neural network providing device comprising:
a plurality of neuron layers; and
a plurality of synaptic layers,
wherein the plurality of neuron layers, and the plurality of synaptic layers are simulated,
a spike signal is processed, and
a predetermined delay is applied to timing when a bias is provided to the plurality of neuron layers.

2. The spiking neural network providing device of claim 1, wherein
the synaptic layer stores learning model data including a weight and a bias,
each synaptic layer outputs a value obtained by combining a spiking signal output from a previous neuron layer and the weight, and
the neuron layer adds the bias to an output value transmitted from a previous synaptic layer and outputs a result of addition.

3. The spiking neural network providing device of claim 1, wherein
a delay applied when the bias is provided is adjusted according to one of a latency of the neuron layer to which a corresponding bias is provided and a latency of the synaptic layer located at a front of the neuron layer to which the corresponding bias is provided.

4. The spiking neural network providing device of claim 1, further comprising:
a synaptic array in which the synaptic layer is implemented;
a neuron circuit in which the neuron layer is implemented, and
a controller configured to control operations of the synaptic array and the neuron circuit,
wherein the controller applies the predetermined delay to the timing when the bias is provided to the plurality of neuron layers.

5. The spiking neural network providing device of claim 1, further comprising:
a memory storing a spiking neural network providing program for implementing operations of the plurality of synaptic layers and the plurality of neuron layers; and
a processor configured to execute the spiking neural network providing program,
wherein the spiking neural network providing program applies the predetermined delay to the timing when the bias is provided to the plurality of neuron layers.

6. An operating method of a spiking neural network providing device that simulates a plurality of neuron layers and a plurality of synaptic layers, the operating method comprising:
inputting input data to the spiking neural network providing device; and
performing inference, by the plurality of neuron layers and the plurality of synaptic layers, based on learning model data including weights and biases stored in the plurality of synaptic layers,
wherein the performing of the inference is to apply the predetermined delay to the timing when the bias is provided to the plurality of neuron layers.

7. The operating method of claim 6, wherein
a delay applied when the bias is provided is adjusted according to one of a latency of the neuron layer to which a corresponding bias is provided and a latency of the synaptic layer located at a front of the neuron layer to which the corresponding bias is provided.
